(19) United States
(12) Patent Application Publication
(10) Pub. No.: US 2026/0067625 A1
(43) Pub. Date: Mar. 5, 2026

(54) INFORMATION PROCESSING APPARATUS, INFORMATION PROCESSING METHOD, AND STORAGE MEDIUM

(71) Applicant: CASIO COMPUTER CO., LTD., Tokyo (JP)

(72) Inventors: Fuminori SANO, Tokyo (JP); Yasuyuki EBASHI, Tokyo (JP)

(73) Assignee: CASIO COMPUTER CO., LTD., Tokyo (JP)

(21) Appl. No.: 19/319,136

(22) Filed: Sep. 4, 2025

(30) Foreign Application Priority Data
Sep. 4, 2024 (JP) 2024-152024

(51) Int. Cl. H04R 25/00

(52) U.S. Cl. CPC H04R 25/50

(57) ABSTRACT

An information processing apparatus includes at least one processor, wherein the at least one processor sets an estimated initial value of hearing for a frequency different from some frequencies of a plurality of frequencies based on first test values of the hearing of a user who has undergone a hearing test for the frequencies of the plurality of frequencies.

### CROSS-REFERENCE TO RELATED APPLICATION

This application claims the benefit of Japanese Patent Application No. 2024-152024, filed on Sep. 4, 2024, the entire disclosure of which is incorporated by reference herein.

### TECHNICAL FIELD

The present disclosure relates to an information processing apparatus, an information processing method, and a storage medium.

### BACKGROUND

A parameter (for example, an amplification factor for each frequency) of a hearing aid device is set based on a result of a hearing test for a user (for example, see WO2020/217359A). The hearing aid device is, for example, a medical hearing aid, a sound collector, or a hearing aid.

A hearing aid device (for example, an over-the-counter (OTC) hearing aid) having a self-fitting function has been known. For example, a user can operate an application linked with such a hearing aid device using a terminal device such as a smartphone, test hearing by himself/herself, and set the hearing aid device based on the test result.

An object of embodiments of the present disclosure is to provide an information processing apparatus, an information processing method, and a storage medium capable of reducing an operation burden on a user.

### SUMMARY

An information processing apparatus according to an embodiment includes at least one processor, wherein the at least one processor sets an estimated initial value of hearing for a frequency different from some frequencies of a plurality of frequencies based on first test values of the hearing of a user who has undergone a hearing test for the some frequencies of the plurality of frequencies.

### BRIEF DESCRIPTION OF THE DRAWINGS

FIG. 1 is a block diagram illustrating a configuration of a system according to an embodiment of the present disclosure;

FIG. 2 is a block diagram illustrating a configuration of an information processing apparatus according to the embodiment of the present disclosure;

FIG. 3 is a view illustrating an overview of a hearing test for self-fitting in the embodiment of the present disclosure;

FIG. 4 is a view illustrating an overview of a hearing test for self-fitting in the embodiment of the present disclosure;

FIG. 5 is a flowchart illustrating processing executed by the information processing apparatus in the embodiment of the present disclosure;

FIG. 6 is a subroutine of a first test process (steps S102 and S202) in FIG. 5;

FIG. 7 is a subroutine of a second test process (steps S103 and S203) in FIG. 5;

FIG. 8 is a subroutine of an estimation process (step S401) in FIG. 7;

FIG. 9 is a view illustrating an example of a screen displayed on an application operated by a user according to the embodiment of the present disclosure;

FIG. 10 is a view supplementing the description of the estimation process (step S401) in FIG. 7;

FIG. 11 is a flowchart illustrating processing executed by the information processing apparatus in a first modified example of the present disclosure;

FIG. 12A is a graph schematically illustrating age-specific hearing levels of male; and

FIG. 12B is a graph schematically illustrating age-specific hearing levels in female.

### DETAILED DESCRIPTION

The following description relates to an information processing apparatus, an information processing method, and a storage medium according to an embodiment of the present disclosure. Common or corresponding elements are denoted by the same or similar reference signs, and redundant description is appropriately simplified or omitted.

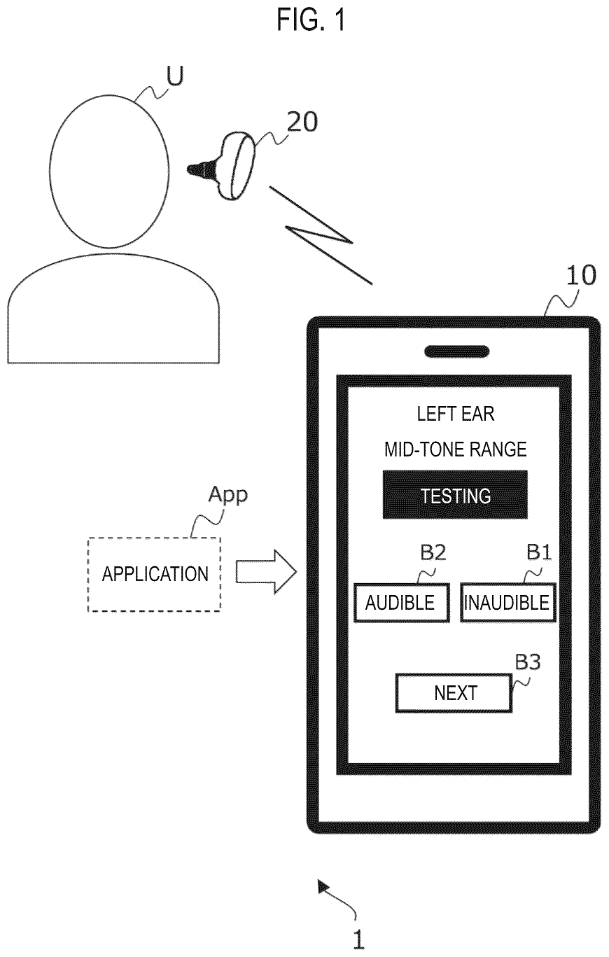

As illustrated in FIG. 1, a system 1 according to the embodiment of the present disclosure includes an information processing apparatus 10 and a hearing aid device 20. The information processing apparatus 10 and the hearing aid device 20 are connected to be capable of communicating with each other according to a wireless communication standard such as Wi-Fi, Bluetooth (registered trademark), or infrared (IR) communication.

The information processing apparatus 10 is an example of a computer. The information processing apparatus 10 is, for example, a smartphone, a tablet terminal, a personal computer (PC), or a dedicated apparatus for hearing measurement. For example, a smartphone can operate as the information processing apparatus 10 by downloading, from an app store, and installing an application App (an example of a program) that executes various processes according to the embodiment of the present disclosure. In this case, for example, a user U can operate the information processing apparatus 10 by performing a touch operation on a graphical user interface (GUI) screen on which various components are laid out. The application App may be a server-side program. For example, the user U may access a server with a web browser of a PC to operate the application App.

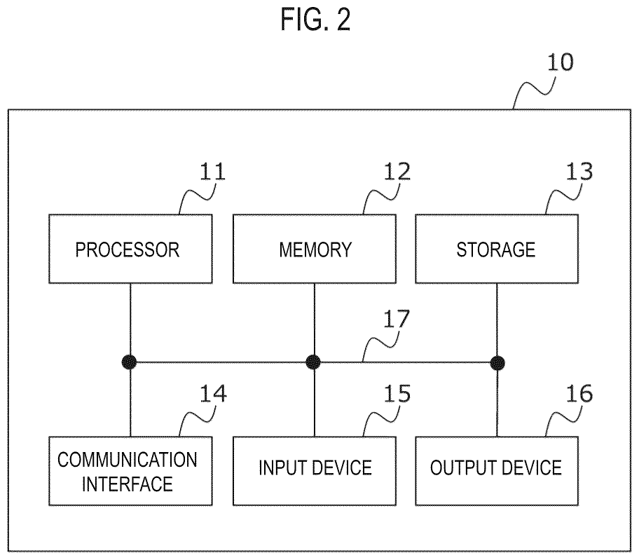

As illustrated in FIG. 2, the information processing apparatus 10 includes a processor 11, a memory 12, a storage 13, a communication interface 14, an input device 15, and an output device 16. Each unit of the information processing apparatus 10 is connected via a bus 17. Note that FIG. 2 merely illustrates an example of a configuration of the information processing apparatus 10. The information processing apparatus 10 may include other elements not illustrated in FIG. 2. The information processing apparatus 10 may be configured not to include some elements illustrated in FIG. 2. The processor 11 may include a single unit or a plurality of processors.

The processor 11 reads various programs and various types of data stored in the storage 13. The memory 12 is, for example, a random access memory (RAM). The processor 11 comprehensively controls the information processing apparatus 10 by using the memory 12 as a work area.

The processor 11 is, for example, a single processor or a multiprocessor, and includes at least one processor. In the case of a configuration including a plurality of processors, the processor 11 may be packaged as a single device, or may be configured by a plurality of devices physically separated in the information processing apparatus 10. The processor 11 may be referred to as, for example, a control unit, a central processing unit (CPU), a micro processor unit (MPU), or a micro controller unit (MCU).

The storage 13 is, for example, a storage medium including at least any of a nonvolatile semiconductor memory such as a flash memory, an erasable programmable ROM (EPROM), or an electrically erasable programmable ROM (EEPROM), a hard disk drive (HDD), or a solid state drive (SSD). The storage 13 stores various programs and various types of data. For example, as the processor 11 executes the application App stored in the storage 13, various processes (setting of an amplification factor for each frequency in the hearing aid device 20 and the like) according to the embodiment of the present disclosure are executed.

The communication interface 14 is a communication interface with an external device. The information processing apparatus 10 is connected to the external device (for example, the hearing aid device 20, a PC, or the like) via the communication interface 14 so as to be capable of communicating with each other. The input device 15 includes, for example, a touch panel, an operation button, a microphone, a camera, a sensor, and the like. The input device 15 may include a keyboard, a mouse, and the like. The output device 16 includes a display, a speaker, and the like. The display is, for example, a touch panel display. The display is, for example, a liquid crystal display (LCD), an organic electro luminescence (EL) display, or a light emitting diode (LED) display.

In the present embodiment, the hearing aid device 20 is a medical hearing aid. For example, the user U uses the hearing aid device 20 worn on one or both of the right ear and the left ear diagnosed to have a hearing loss. When both the ears are diagnosed to have a hearing loss, the user U uses a pair of the hearing aid devices 20 and 20 worn on the respective ears.

In general, a hearing test is performed for seven to nine frequencies (or frequency bands). In the hearing test, a user operates a terminal device to gradually change a sound pressure level of a hearing test sound from an initial sound pressure level to an appropriate sound pressure level considered to be appropriate for the user. The user performs such an operation for all the frequencies to be subjected to the hearing test. As the initial sound pressure level and the appropriate sound pressure level deviate from each other, the number of operations (in other words, the number of times the sound pressure level of the hearing test sound is changed) increases. There is a case where several tens of operations may be required for one frequency (or frequency band), and as a result, a significant number of operations may be required to complete the hearing test for all the frequencies (or frequency bands) to be heard. Therefore, an operation burden on the user U during the hearing test is great. On the other hand, in the present embodiment, the user U can perform self-fitting of the hearing aid device 20 with a small operation burden by operating the application App installed in the information processing apparatus 10.

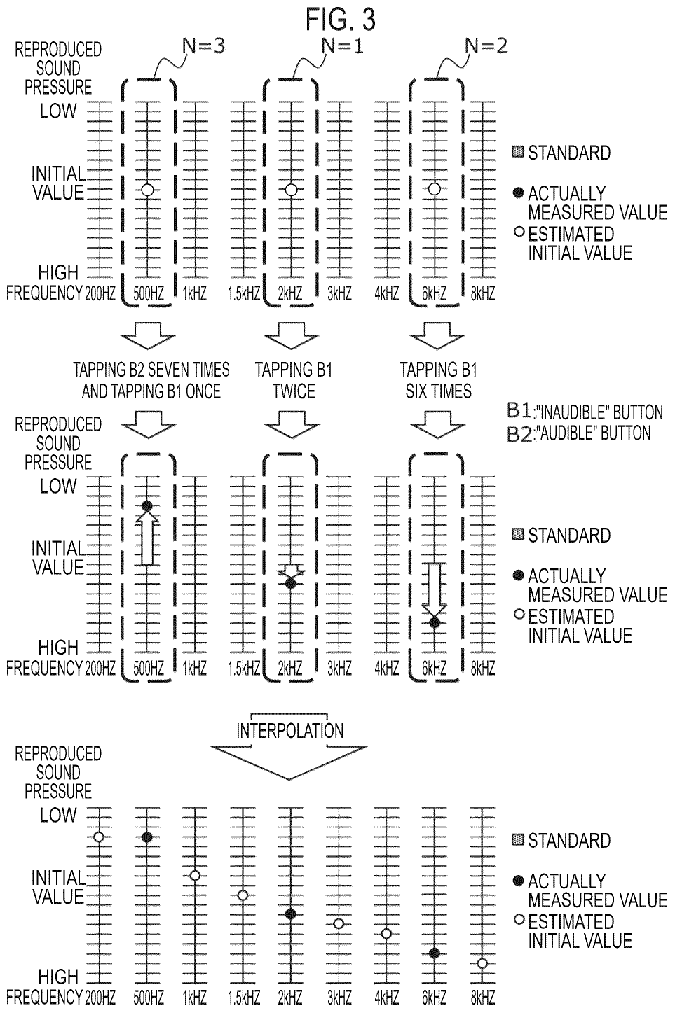

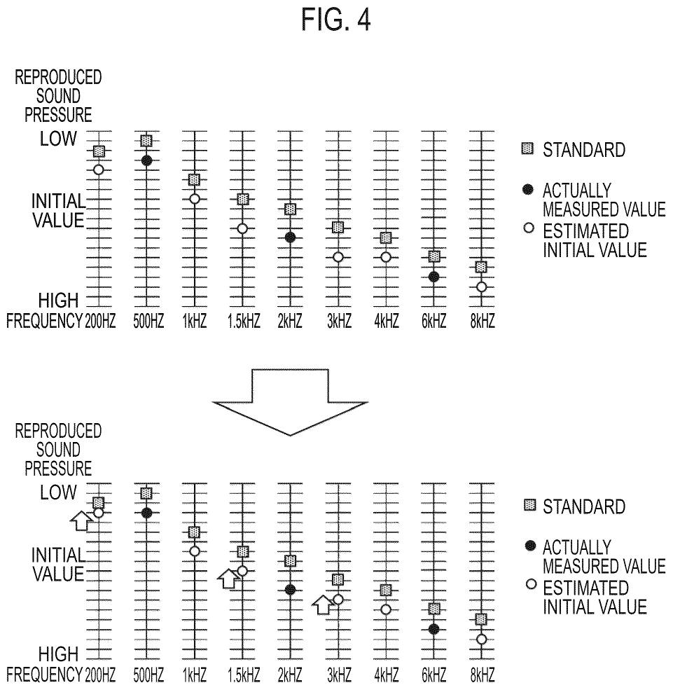

An overview of a hearing test for self-fitting in the present embodiment will be described with reference to FIGS. 3 and 4. In graphs in FIGS. 3 and 4, the horizontal axis represents frequencies (unit: Hz) of hearing test sounds. The vertical axis represents reproduced sound pressures (sound pressure levels (unit: dBSPL) of the hearing test sounds). An “initial value” described on the vertical axis represents, for example, a sound pressure level determined based on the average hearing ability of assumed users who use devices equipped with this function. Note that the initial value mentioned herein is merely an example. There are various information processing methods for determining the initial value. Hereinafter, the “frequencies” may be read as “frequency bands” that do not overlap each other.

The graphs in FIGS. 3 and 4 may be replaced with audiograms. In this case, the vertical axis is replaced with a hearing level (unit: dBHL). The sound pressure level (unit: dBSPL) and the hearing level (unit: dBHL) can be converted into one another. Therefore, in the hearing test according to the present embodiment, the sound pressure level for each frequency or the hearing level for each frequency may be obtained as a test result (test value).

The amplification factor of the hearing aid device 20 can be set more accurately as the number of frequencies to be tested increases. However, in the related art, the number of required user operations monotonically increases by an increase in the number of frequencies to be tested. On the other hand, in the present embodiment, an increase in the number of user operations accompanying an increase in the number of frequencies to be tested can be suppressed to be small. Therefore, in the present embodiment, the hearing test is performed for nine frequencies (specifically, 200 Hz, 500 Hz, 1 kHz, 1.5 kHz, 2 kHz, 3 kHz, 4 kHz, 6 kHz, and 8 kHz) that are quite large in number. That is, in the present embodiment, it is possible to accurately set the amplification factor of the hearing aid device 20 while suppressing the operation burden on the user.

As illustrated in the upper view and the middle view of FIG. 3, the hearing test in the present embodiment is performed for three frequencies (500 Hz, 2 kHz, 6 kHz) out of the nine frequencies (see black circles). For convenience, these three frequencies are referred to as “actual measurement test frequencies”. A result of the hearing test of the user U for each of the actual measurement test frequencies is a set sound pressure for the actual measurement test frequency, and is described as a “first test value”.

Note that any reference to elements using designations such as “first”, “second”, and the like as used in the present disclosure does not generally limit an amount or order of those elements. These designations are used for convenience to distinguish between two or more elements. Therefore, for example, reference to first and second elements does not mean that only the two elements may be adopted, the first element must precede the second element, or the like.

In the hearing test for the actual measurement test frequencies, for example, an operation screen illustrated in FIG. 1 is displayed on the application App of the information processing apparatus 10. During the hearing test, the hearing aid device 20 worn on the ear of the user U emits a sound (hearing test sound) of a corresponding frequency in accordance with an instruction from the application App.

In the hearing test for the actual measurement test frequencies, first, a hearing test sound with the sound pressure level of the initial value (see the black circles in the upper view of FIG. 3) is emitted. The user U taps an “Inaudible” button B1 if the hearing test sound is inaudible. Then, a hearing test sound (a value lowered by one level on the vertical axis in FIG. 3) with a sound pressure level changed to be higher by one level (for example, a sound pressure equivalent to 5 dBHL) is emitted. The user U taps an “Audible” button B2 if the hearing test sound is audible. Then, a hearing test sound (a value raised by one level on the vertical axis in FIG. 3) with a sound pressure level changed to be lower by one level (for example, a sound pressure equivalent to 5 dBHL) is emitted.

For example, the user U taps the “Inaudible” button B1 or the “Audible” button B2 until the appropriate sound pressure level is reached (that is, until an inaudible hearing test sound becomes audible). When the appropriate sound pressure level is reached, the user U taps a “Next” button B3. Then, the processor 11 that executes the application App records the actual measurement test frequency and the sound pressure level at that time in association with each other, for example, in the storage 13. That is, the processor 11 records the first test value (the set sound pressure for the actual measurement test frequency).

In the example of FIG. 3, the user U hears a sound at 500 Hz, which is one of the actual measurement test frequencies output by the hearing aid device 20, and taps the “Audible” button B2. At this time, the user U can hear the sound even after the tapping, and thus repeatedly taps the “Audible” button B2 each time, and then taps the “Inaudible” button B1 once and taps the “Next” button B3 as the hearing test sound is no longer audible at the time when the tapping has been repeated seven times. Then, a sound pressure level that is lower by six levels than the initial value (that is, the lowest sound pressure level audible to the user U) is recorded in association with 500 Hz (see the black circle corresponding to 500 Hz). Since an output sound of 2 kHz, which is one of the actual measurement test frequencies, is inaudible, the user U taps the “Inaudible” button B1, and then taps the “Next” button B3 as the hearing test sound becomes audible at the time when the tapping has been performed twice. Then, a sound pressure level higher by two levels than the initial value is recorded in association with 2 kHz (see the black circle corresponding to 2 kHz). Since an output sound of 6 kHz, which is one of the actual measurement test frequencies, is inaudible, the user U taps the “Inaudible” button B1, and finally taps the “Next” button B3 as the hearing test sound becomes audible at the time when the tapping has been performed six times. Then, a sound pressure level six levels higher than the initial value is recorded in association with 6 kHz (see the black circle corresponding to 6 kHz). In this manner, the processor 11 that executes the application App acquires the first test values (that is, the sound pressure levels for the three actual measurement test frequencies) of the hearing of the user U for the three actual measurement test frequencies (an example of some frequencies among a plurality of frequencies).

The processor 11 that executes the application App sets initial values of the hearing of the user U for the remaining frequencies (that is, 200 Hz, 1 kHz, 1.5 kHz, 3 kHz, 4 kHz, and 8 kHz) to estimated initial values based on the first test values and feature information of the user U as illustrated in white circles in the lower view of FIG. 3, and sets second test values based on an operation of the user U who has undergone the hearing test based on the estimated initial values. A value on the vertical axis of a white circle is a value having an upper limit, which is one of values of black circles on the left and right sides of the white circle, and a lower limit, which is the other, and is more preferably a value between the values of the black circles on the left and right sides. In a case where a black circle is present only on one of the left and right sides, the estimated initial value may be set based on the black circle at the closest frequency. That is, the estimated initial value is an estimated value interpolated based on the first test value. For convenience, the remaining six frequencies are described as “untested frequencies”. A result of the hearing test of the user U for each of the untested frequencies is a set sound pressure for the untested frequency, and is described as the “second test value”. The estimated initial value is a value provisionally set from the first test value and the feature information of the user before execution of a second test to be described later. The estimated initial value indicates a sound pressure level for the untested frequency (that is, a sound pressure level estimated to be audible to the user U). The second test value is a result obtained by performing the hearing test from the sound pressure level of the estimated initial value.

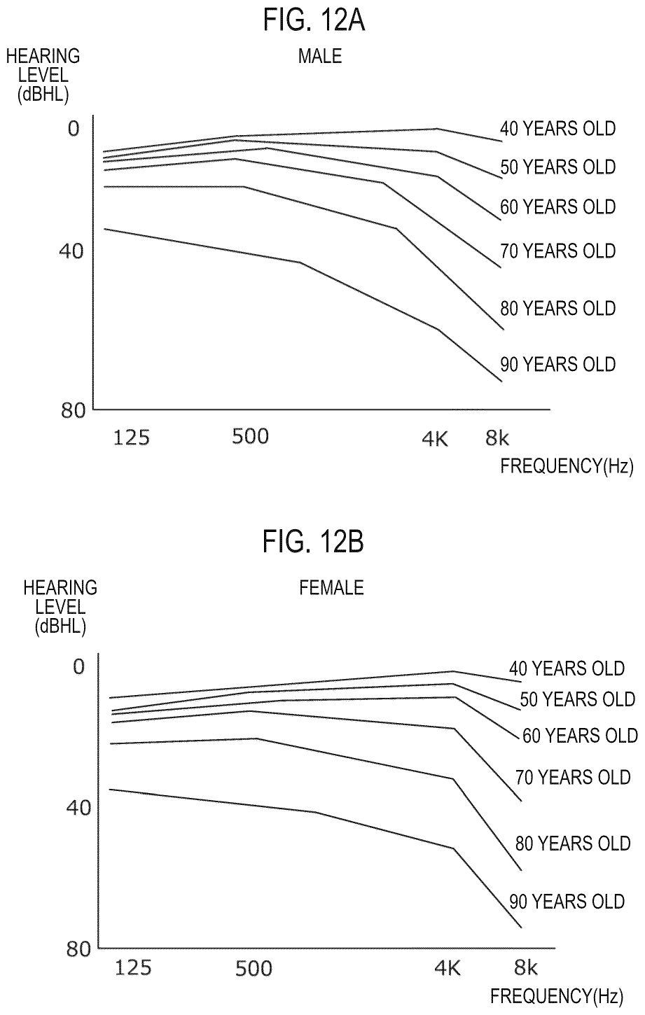

Graphs in FIGS. 12A and 12B schematically illustrate tendencies of hearing of male and female, respectively. In FIGS. 12A and 12B, the vertical axis represents a hearing level (unit: dBHL). The horizontal axis represents a frequency (unit: Hz). For example, as illustrated in FIGS. 12A and 12B, the hearing decreases with age. In general, there is a gender difference that a decrease in hearing of a high tone with aging tends to be larger in male than in female. There is a case where a decrease in hearing is larger in a low tone than in a high tone depending on a chronic disease of the user U, and there is a case where a mid-tone range is less audible than a low-tone range or a high-tone range.

Therefore, the processor 11 that executes the application App refers to the feature information of the user U for acquiring the estimated initial value. The feature information of the user U includes at least one of age, gender, and a medical history. These pieces of feature information are registered in the application App in advance, for example. Here, in FIG. 4, a square plot indicates, for example, a standard sound pressure level at the age of the user U. The square plot may indicate a standard sound pressure level in the gender of the user U. The square plot may indicate a standard sound pressure level at the age and gender of the user U.

Here, in the example illustrated in FIG. 4, a sound pressure level (see a black circle) for each of the actual measurement test frequencies indicated by the first test value is higher than the standard sound pressure level (see the square plot) at the age of the user U. Therefore, as illustrated in the upper view of FIG. 4, the processor 11 that executes the application App provisionally sets the estimated initial value of the sound pressure level for each of the untested frequencies to a value higher than the standard sound pressure level at the age of the user U.

For example, at the actual measurement test frequency (500 Hz), the first test value is higher by two levels than the standard sound pressure level. Therefore, at each of the untested frequencies (200 Hz and 1 kHz) on both sides of the actual measurement test frequency (500 Hz), the estimated initial value is provisionally set to a value that is higher by two levels than the standard sound pressure level. For example, at the actual measurement test frequency (2 kHz), the first test value is higher by three levels than the standard sound pressure level. Therefore, at each of the untested frequencies (1.5 kHz and 3 kHz) on both sides of the actual measurement test frequency (2 Hz), the estimated initial value is provisionally set to a value that is higher by three levels than the standard sound pressure level. For example, at the actual measurement test frequency (6 kHz), the first test value is higher by two levels than the standard sound pressure level. Therefore, at each of the untested frequencies (4 kHz and 8 kHz) on both sides of the actual measurement test frequency (6 kHz), the estimated initial value is provisionally set to a value higher by two levels than the standard sound pressure level. In this manner, the estimated initial value is set based on a difference between an actually measured value and a standard value of the closest frequency.

That is, the processor 11 that executes the application App changes the initial value of hearing (for example, the sound pressure level determined based on the average hearing ability of assumed users who use devices equipped with this function) preset for the remaining frequency (for example, six untested frequencies) among the plurality of frequencies to the estimated initial value based on the first test value (for example, the sound pressure level for each of the three actual measurement test frequencies) of the hearing of the user U who has undergone the hearing test for some frequency (for example, three actual measurement test frequencies) among the plurality of frequencies.

The processor 11 that executes the application App sequentially displays several questions about a medical history, a lifestyle, a work environment, and the like on the screen of the information processing apparatus 10. As illustrated in the lower view of FIG. 4, the processor 11 adjusts the provisionally set estimated initial value of the sound pressure level for each of the untested frequencies according to answers of the user U to the above questions. For example, in a case where the user U has otitis media, a sound pressure level in the low-tone range, such as 200 Hz, is increased by at least one level (that is, lowered by one level on the vertical axis in FIG. 4) by the processor 11 according to the degree of symptoms estimated from the answer result. In this manner, the sound pressure level for the untested frequency for which the actual hearing test has not been performed is interpolated. In the example of the lower view of FIG. 4, the processor 11 changes the sound pressure levels of 200 Hz, 1.5 Hz, and 3 kHz from the estimated initial values of the upper view of FIG. 4 by one level based on the medical history, the lifestyle, the workplace environment, and the like.

The adjusted estimated initial value is an estimated value of the sound pressure level for the untested frequency. That is, the processor 11 that executes the application App estimates the estimated initial values (that is, the sound pressure levels for the six untested frequencies) based on the first test values (that is, the sound pressure levels for the three actual measurement test frequencies) and the feature information (such as age) of the user U.

The processor 11 of the information processing apparatus 10 may fix and record these estimated initial values as the set sound pressures for the untested frequencies in the storage 13. In other words, the processor 11 may regard these estimated initial values as the second test values and record these in the storage 13. In this case, substantially no operation of the user U is required to set the sound pressure levels for the untested frequencies. Therefore, the operation burden on the user U is reduced as compared with the related art. Furthermore, as the operation burden on the user U is reduced, the processing on the second test value in the processor 11 can be reduced.

The hearing test may be performed using each of the estimated initial values as a starting point in order to set the sound pressure levels for the untested frequencies with higher accuracy. Also in the hearing test for the untested frequencies, the operation screen illustrated in FIG. 1 is displayed on the application App of the information processing apparatus 10. During the hearing test, the hearing aid device 20 worn on the ear of the user U emits a sound (hearing test sound) of a corresponding frequency in accordance with an instruction from the application App.

In the hearing test for the untested frequencies, first, the emission of the hearing test sound is started from the sound pressure levels of the estimated initial values illustrated in the lower view of FIG. 3 or the lower view of FIG. 4. Since the estimated initial values are set based on the set sound pressures for the actual measurement test frequencies and the feature information of the user U, a deviation between the sound pressure level of each of the estimated initial values and an appropriate sound pressure level tends to be small. The user U can find the appropriate sound pressure level with a small number of operations. Therefore, also in this case, the operation burden on the user U is reduced as compared with the related art, and processing on the second test values in the processor 11 can be mitigated with the reduction in the operation burden on the user U.

In this manner, the processor 11 that executes the application App sets (for example, fixes) the second test value (that is, the sound pressure level for each of the six untested frequencies) based on the operation (such as the operation of tapping the “Inaudible” button B1 or the “Audible” button B2) of the user U who has undergone the hearing test (for example, the hearing test using the estimated initial value of the sound pressure level for each of the six untested frequencies) based on the estimated initial value.

In the examples of FIGS. 3 and 4, the actual measurement test frequencies are 500 Hz, 2 kHz, and 6 kHz, and are set to be distributed to the low-tone range, the mid-tone range, and the high-tone range, respectively. The low-tone range is, for example, 20 Hz to 600 Hz. The mid-tone range is, for example, 800 Hz to 2 kHz. The high-tone range is, for example, 4 kHz to 20 kHz. Note that numerical values of the respective frequency ranges described herein are examples. Since the actual measurement test frequencies are discretely arranged, the accuracy of the estimated initial values of the sound pressure levels for the untested frequencies can be ensured in a well-balanced manner over the entire band. In this manner, the actual measurement test frequencies (an example of some frequencies among the plurality of frequencies) include, for example, at least one frequency included in the low-tone range, at least one frequency included in the mid-tone range, and at least one frequency included in the high-tone range.

The frequency of general daily conversation is, for example, 250 Hz to 4000 Hz. Therefore, at least one actual measurement test frequency is desirably included in this range. The number of actual measurement test frequencies is not limited to three. In order to further reduce the operation burden on the user U, one or two actual measurement test frequencies may be used.

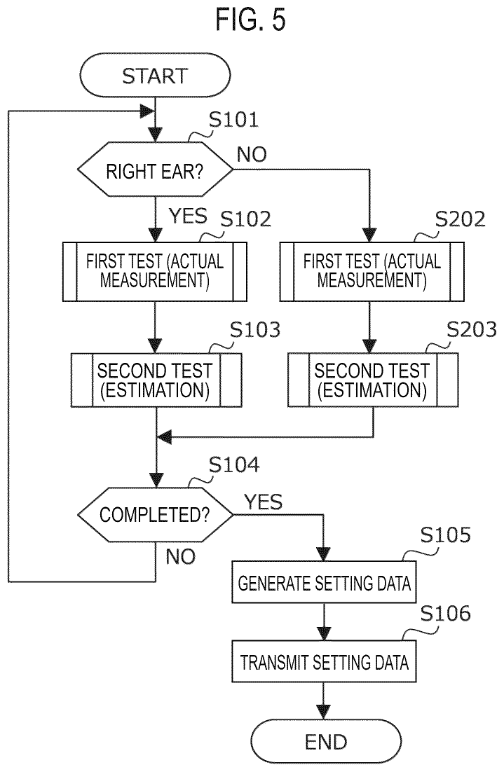

Processing executed by the processor 11 operating the application App in the information processing apparatus 10 will be described with reference to FIGS. 5 to 10. For example, when the application App is activated, execution of the processing illustrated in FIG. 5 is started. When the execution of this processing is started, for example, a guidance prompting the user U to wear the hearing aid device 20 flows on the application App.

Note that order of each step of the flowchart indicated in the embodiment of the present disclosure may be changed within a range without inconsistency. For example, in the embodiment of the present disclosure, the processing including various steps is presented using exemplary order as the hearing test on the right and left ears, but the embodiment of the present disclosure is not limited to this presented order. Furthermore, the steps of the flowchart indicated in the embodiment of the present disclosure may be executed in parallel within a range without inconsistency.

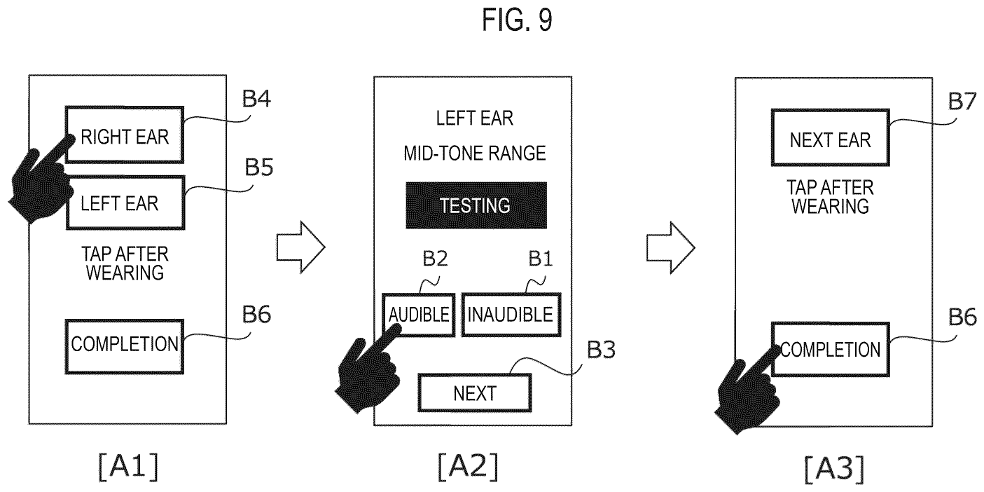

As illustrated in FIG. 5, the processor 11 inquires of the user U about the ear on which the hearing test is to be performed (step S101). As an example, as illustrated in a screen example A1 of FIG. 9, a screen on which ear selection buttons B4 and B5 and a completion button B6 are arranged is displayed on the application App. When the user U taps the ear selection button B4, the processor 11 recognizes the right ear as a subject of the hearing test (step S101: YES) and performs the first test on the right ear (step S102). When the user U taps the ear selection button B5, the processor 11 recognizes the left ear as the subject of the hearing test (step S101: NO), and performs the first test on the left ear (step S202). Note that the processor 11 may end the processing of the hearing test halfway by tapping an end button (not illustrated) during execution of any of steps S102, S103, S202, and S203. In this case, setting data may be generated in step S105 using only data that has already been processed and may be stored in the storage 13 or an external server.

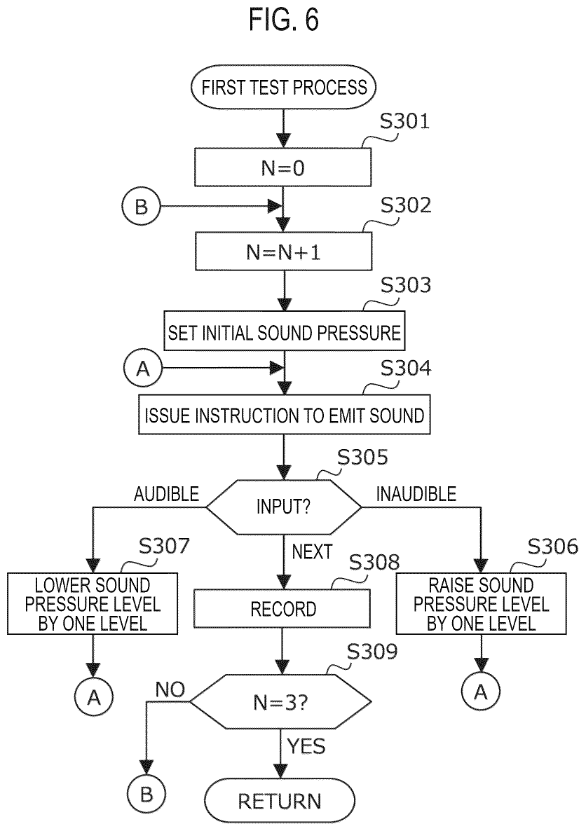

A subroutine of the first test process (steps S102 and S202) will be described with reference to FIG. 6. A difference between the process in step S102 and the process in step S202 is only whether the subject of the hearing test is the right ear or the left ear. The processes in step S102 and step S202 have the same content as illustrated in FIG. 6.

As illustrated in FIG. 6, the processor 11 resets a variable N to zero (step S301). The processor 11 increases the variable N by one (step S302). The variable N indicates a test target frequency. For example, when the variable N is Value 1, 2 kHz is the test target frequency.

When the variable N is Value 2, 6 kHz is the test target frequency. When the variable N is Value 3, 500 Hz is the test target frequency. In the present embodiment, the hearing test is performed in the order of the mid-tone range (2 kHz), the high-tone range (6 kHz), and the low-tone range (500 Hz). However, the order of the hearing test is not limited thereto. The hearing test may be performed in another order (for example, in the order of the low-tone range, the mid-tone range, and the high-tone range).

The processor 11 sets an initial sound pressure of a hearing test sound of an actual measurement test frequency indicated by the variable N (step S303). The initial sound pressure for the actual measurement test frequency is set to, for example, an estimated initial value of a standard value indicated by the white circle in the upper view of FIG. 3.

The processor 11 displays a screen (see a screen example A2 in FIG. 9) for input of a response of the user U with respect to the hearing test sound, and instructs the hearing aid device 20 to emit the hearing test sound of the actual measurement test frequency indicated by the variable N at a current sound pressure level (the initial sound pressure set in step S303 immediately after the update of the variable N) (step S304). The hearing aid device 20 having received this instruction emits the hearing test sound of the actual measurement test frequency indicated by the variable N at the current sound pressure level.

The user U inputs the response to the hearing test sound emitted by the hearing aid device 20 (step S305). Specifically, the user U taps the “Inaudible” button B1 if the hearing test sound is inaudible. The user U taps the “Audible” button B2 if the hearing test sound is audible. When the hearing test sound reaches an appropriate sound pressure level (for example, when the inaudible hearing test sound becomes audible), the user U taps the “Next” button B3.

When the “Inaudible” button B1 is tapped (step S305: inaudible), the sound pressure level of the hearing test sound of the actual measurement test frequency indicated by the variable N is raised by one level, that is, lowered by one level on the vertical axis in FIG. 3 by the processor 11 (step S306). When the “Audible” button B2 is tapped (step S305: audible), the sound pressure level of the hearing test sound of the actual measurement test frequency indicated by the variable N is lowered by one level, that is, raised by one level on the vertical axis in FIG. 3 by the processor 11 (step S307). The processor 11 instructs the hearing aid device 20 to emit the hearing test sound of the actual measurement test frequency indicated by the variable N at the updated sound pressure level (step S304). The hearing aid device 20 that has received this instruction emits the hearing test sound of the actual measurement test frequency indicated by the variable N at the updated sound pressure level. This series of processing of observing the response of the user U to the hearing test sound is repeated until the “Next” button B3 is tapped.

When the “Next” button B3 is tapped (step S305: next), the processor 11 records the actual measurement test frequency indicated by the variable N and a current sound pressure level in the storage 13 in association with each other (step S308). The processor 11 determines whether the variable N is, for example, Value 3 (step S309). When the variable N is Value 3 (step S309: YES), the sound pressure levels have been recorded for all the three actual measurement test frequencies (500 Hz, 2 kHz, 6 kHz). Therefore, the processor 11 ends this subroutine. When the variable N is not Value 3 (step S309: NO), there remains an actual measurement test frequency for which a sound pressure level has not been recorded yet. Therefore, the processor 11 returns to the process in step S302 and performs processing for the next actual measurement test frequency.

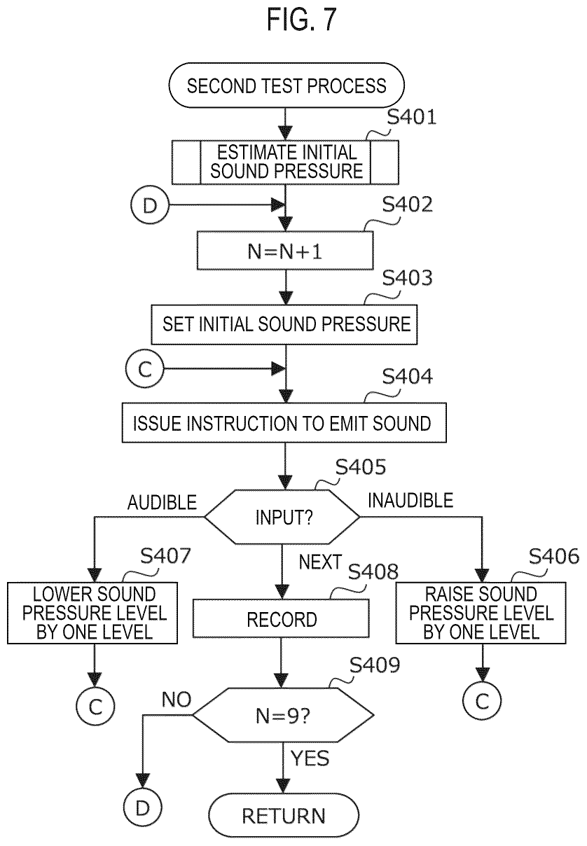

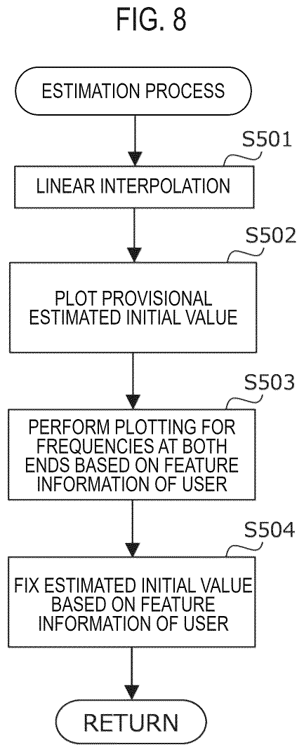

After the execution of the first test process (step S102), the processor 11 performs the second test process (step S103). Similarly, after the execution of the first test process (step S202), the processor 11 executes the second test process (step S203). A subroutine of the second test process (steps S103 and S203) will be described with reference to FIGS. 7 and 8. A difference between the process in step S103 and the process in step S203 is also only whether the subject of the hearing test is the right ear or the left ear. The processes in step S103 and step S203 have the same content as illustrated in FIG. 7.

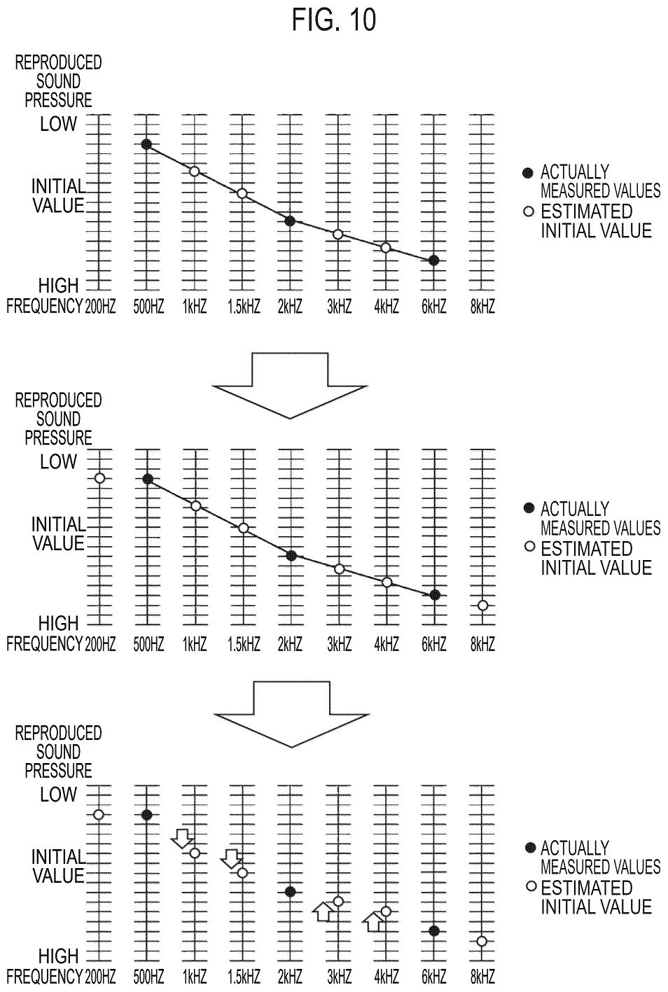

The processor 11 estimates an initial sound pressure for an untested frequency (step S401). A subroutine of the estimation process illustrated in FIG. 8 will be described with reference to FIG. 10. Note that the estimation process described here is different from the estimation process described with reference to FIG. 4. That is, various methods can be adopted to estimate the initial sound pressure for the untested frequency.

As illustrated in the upper view of FIG. 10, the processor 11 connects black circles of the actual measurement test frequencies (500 Hz, 2 kHz, and 6 kHz) by linear interpolation (step S501). As indicated by white circles in the upper view of FIG. 10, the processor 11 plots provisional estimated initial values at intersections with interpolation lines on four untested frequencies (1 kHz, 1.5 kHz, 3 kHz, and 4 kHz) (step S502). Note that not only the linear interpolation but also curve interpolation (higher-order spline curve, B-spline curve, Lagrange interpolation, or the like) may be applied to the interpolation processing.

As illustrated in the upper view of FIG. 10, there is no intersection with the interpolation lines on untested frequencies (200 Hz and 8 kHz) at both ends. Therefore, in step S502, estimated initial values for the two untested frequencies cannot be plotted. Therefore, in step S503, the processor 11 plots provisional estimated initial values at positions on the untested frequencies (200 Hz and 8 kHz) at both the ends based on the feature information (age, gender, or the like) of the user (see the middle view of FIG. 10).

For example, the processor 11 plots standard sound pressure levels at the age of the user U for the untested frequencies at both the ends (200 Hz and 8 kHz) as provisional estimated initial values. The processor 11 may further adjust the provisional estimated initial value for 200 Hz according to the sound pressure level set at the adjacent actual measurement test frequency (500 Hz). For example, in a case where the sound pressure level set at the actual measurement test frequency (500 Hz) is higher than a standard sound pressure level of 500 Hz at the age of the user U by a predetermined value or more, the processor 11 adjusts the estimated initial value for 200 Hz to be higher than the standard sound pressure level of 200 Hz by a predetermined value. For example, in a case where the sound pressure level set at the actual measurement test frequency (500 Hz) is lower than the standard sound pressure level of 500 Hz at the age of the user U by a predetermined value or more, the processor 11 adjusts the estimated initial value for 200 Hz to be lower than the standard sound pressure level of 200 Hz by a predetermined value. The same applies for 8 kHz. The processor 11 may adjust the provisional estimated initial value for 8 kHz according to the sound pressure level set at the adjacent actual measurement test frequency (6 kHz). For example, in a case where the sound pressure level set at the actual measurement test frequency (6 kHz) is higher than a standard sound pressure level of 6 kHz at the age of the user U by a predetermined value or more, the processor 11 adjusts the estimated initial value for 8 kHz to be higher than the standard sound pressure level of 8 kHz by a predetermined value. For example, in a case where the sound pressure level set at the actual measurement test frequency (6 kHz) is lower than a standard sound pressure level of 6 kHz at the age of the user U by a predetermined value or more, the processor 11 adjusts the estimated initial value for 8 kHz to be lower than the standard sound pressure level of 8 kHz.

In step S503, instead of the plotting process based on the feature information of the user U, the processor 11 may extend the interpolation lines calculated in step S501 to positions of the two untested frequencies (200 Hz and 8 kHz), and plot the estimated initial values at intersections with the extended interpolation lines on the two untested frequencies (200 Hz and 8 kHz). In this case, the processor 11 can determine the estimated initial values of all the untested frequencies without using the feature information of the user U. That is, the processor 11 can change the initial values of hearing, set in advance for the untested frequencies that are the remaining frequencies, to the estimated initial values based on the first test values of the actual measurement test frequencies.

In step S504, the processor 11 further adjusts the provisional estimated initial value for each of the untested frequencies (200 Hz, 1 kHz, 1.5 kHz, 3 kHz, 4 kHz, and 8 kHz) based on the feature information (answers to several questions about a medical history, a lifestyle, a work environment, and the like) of the user U, and fixes the estimated initial values (see the lower view of FIG. 10). As an example, in a case where the user U has a chronic disease that makes it difficult to hear the mid-tone and low-tone ranges, sound pressure levels for the mid-tone and low-tone ranges are raised (lowered by one level on the vertical axis in the lower view of FIG. 10) by the processor 11. Note that it is assumed that the questions about the medical history, the lifestyle, the work environment, and the like are asked on the application App in advance, for example, at a timing immediately after the activation of the application App or the like.

Here, in the initial stage of the second test process after the first test process, the variable N indicates Value 3, and Values 4, 5, 6, 7, 8, and 9 of the variable N are assigned to the frequencies 200 Hz, 1 kHz, 1.5 kHz, 3 kHz, 4 kHz, and 8 kHz, which are the untested frequencies, respectively. The processor 11 estimates the initial sound pressure for the untested frequency in step S401, and then performs processing similar to steps S302 to S309 in FIG. 6 (steps S402 to S409). Specifically, the processor 11 increases the variable N by one (step S402), and sets the initial sound pressure of the hearing test sound of the untested frequency indicated by the variable N to the estimated initial value estimated in step S401 (step S403).

Since the emission of the hearing test sound can be started with the estimated initial value (that is, an appropriate sound pressure level or a sound pressure level close to the appropriate sound pressure level), the user U can find the appropriate sound pressure level with a small number of operations (steps S405 to S408). Therefore, the operation burden on the user U is reduced, and the processing on the second test values in the processor 11 can be mitigated with the reduction in the operation burden on the user U.

In step S409, the processor 11 determines whether the variable N is Value 9. When the variable N is Value 9 (step S409: YES), the sound pressure levels have been recorded for all the six actual measurement test frequencies (200 Hz, 1 kHz, 1.5 kHz, 3 kHz, 4 kHz, and 8 kHz). Therefore, the processor 11 ends this subroutine. When the variable N is not Value 9 (step S409: NO), there remains an untested frequency for which a sound pressure level has not been recorded yet. Therefore, the processor 11 returns to the process in step S402 and performs processing for the next untested frequency.

After the execution of the second test process (steps S103 and S203), the processor 11 inquires of the user U about whether the hearing test is completed (step S104). For example, as illustrated in a screen example A3 of FIG. 9, a screen on which the completion button B6 and a switch button B7 are arranged is displayed on the application App. When the user U performs a switching operation (that is, taps the switch button B7) (step S104: NO), the processor 11 returns to step S101 and performs the hearing test on the untested ear.

When the user U taps the completion button B6 (step S104: YES), the processor 11 generates setting data (step S105). Specifically, the processor 11 converts the set sound pressure associated with each of the frequencies (200 Hz, 500 Hz, 1 kHz, 1.5 kHz, 2 kHz, 3 kHz, 4 kHz, 6 kHz, 8 kHz) recorded in the storage 13 into an amplification factor in the hearing aid device 20. That is, the processor 11 generates data in which each of the frequencies is associated with the amplification factor. The processor 11 converts a set sound pressure to a larger amplification factor as the set sound pressure is higher. In other words, the processor 11 converts a set sound pressure to a smaller amplification factor as the set sound pressure is lower. In this manner, the processor 11 that executes the application App determines the amplification factor of each of the frequencies (an example of each of the plurality of frequencies) in the hearing aid device 20 based on the first test value (that is, the sound pressure level for each of the three actual measurement test frequencies) and the second test value (that is, the sound pressure level for each of the six untested frequencies).

The processor 11 transmits the setting data generated in step S105 to the hearing aid device 20 (step S106). The hearing aid device 20 sets the amplification factor of each of the frequencies (200 Hz, 500 Hz, 1 kHz, 1.5 kHz, 2 kHz, 3 kHz, 4 kHz, 6 kHz, and 8 kHz) according to the received setting data. Then, the hearing aid device 20 amplifies human speech or the like to a sound pressure level suitable for the user U and assists the hearing of the user U. Note that the processor 11 can transmit the setting data generated in step S105 not only to the hearing aid device 20 but also to a sharing destination (a cloud server, a PC, or the like) designated in advance by the user U on the application App, for example. That is, the processor 11 can automatically back up this data.

The above is the description of the exemplary embodiment of the present disclosure. The embodiment of the present disclosure is not limited to that described above, and various modifications can be made within the scope of the technical idea of the present disclosure. For example, the embodiment of the present application also includes content obtained by appropriately combining the embodiment and the like exemplarily specified in the specification or obvious embodiments and the like.

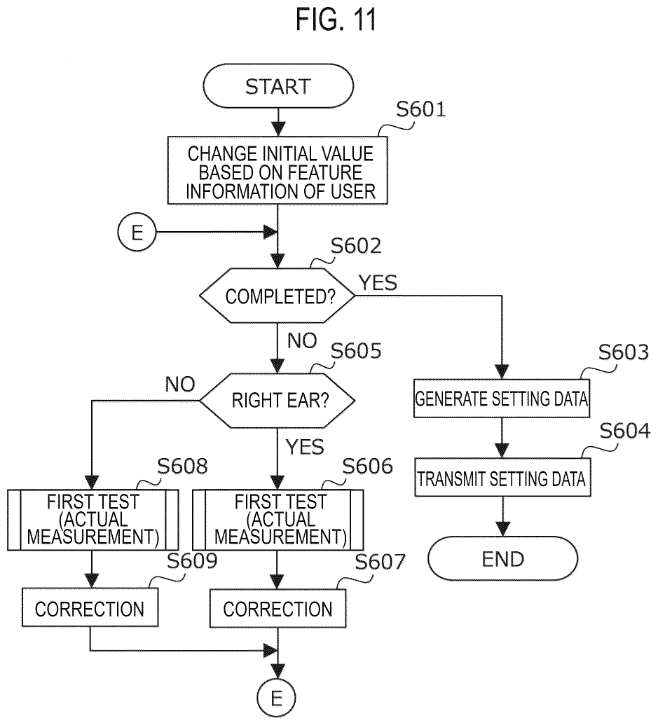

Processing executed by the processor 11 operating the application App in a first modified example of the present disclosure will be described with reference to FIG. 11. For example, when the application App is activated, execution of the processing illustrated in FIG. 11 is started.

In the first modified example, the processor 11 changes the initial values of all the frequencies (specifically, 200 Hz, 500 Hz, 1 kHz, 1.5 kHz, 2 kHz, 3 kHz, 4 kHz, 6 kHz, and 8 kHz) to estimated initial values based on the feature information of the user U (step S601). For example, the processor 11 changes the sound pressure levels of the frequencies from the initial values to the sound pressure levels indicated by the square plots in FIG. 4.

At this time, when the user U performs a completion operation (for example, tapping the completion button B6) (step S602: YES), the processor 11 generates setting data (step S603) and transmits the generated setting data to the hearing aid device 20 (step S604). Then, in the hearing aid device 20, amplification factors of the frequencies are set according to standard setting data corresponding to the feature information of the user U. In this case, the processor 11 can set the estimated initial values of all the frequencies based on the feature information of the user U without using the first test values (that is, the sound pressure levels for the actual measurement test frequencies). Since the hearing test can be omitted, the operation burden on the user U is greatly reduced.

In the first modified example, the user U can obtain more accurate setting data by performing the hearing test on at least one frequency. In this case, for example, the processor 11 performs the first test similar to step S102 of FIG. 5 on the right ear (step S602: NO, step S605: YES, and step S606), and performs the first test similar to step S202 of FIG. 5 on the left ear (step S602: NO, step S605: NO, and step S608).

In the first modified example, for example, the processor 11 performs the hearing test on the right ear for one frequency corresponding to one variable N with the first test performed once (step S606). Every time the first test (step S606) is performed, the processor 11 corrects the estimated initial value of each of the frequencies corresponding to the right ear (step S607). Furthermore, for example, the processor 11 performs the hearing test on the left ear for one frequency corresponding to one variable N with the first test performed once (step S608). Every time the first test (step S608) is performed, the processor 11 corrects the estimated initial value of each of the frequencies corresponding to the left ear (step S609).

For example, it is considered a case where the sound pressure level of the actual measurement test frequency (500 Hz) acquired in the first test (step S606) is higher by two levels than the estimated initial value based on the feature information of the user U acquired in step S601. In this case, the processor 11 corrects the sound pressure levels of the frequencies (200 Hz and 1 kHz) on both sides of 500 Hz to values one level higher than the estimated initial values based on the feature information of the user U acquired in step S601 (step S607). The processor 11 can improve the accuracy of the setting data as the first test and the correction process (steps S606 to S609) are repeated.

Furthermore, the program of the application App is stored in the storage 13, but is not limited thereto, and may be stored in a removable storage medium such as a USB memory, a CD, or a DVD, or may be stored in a storage medium of a server that can communicate with the information processing apparatus 10. The information processing apparatus 10 may read and execute the program from such a storage medium.

What is claimed is:

1. An information processing apparatus comprising at least one processor, wherein the at least one processor sets an estimated initial value of hearing for a frequency different from some frequencies of a plurality of frequencies based on first test values of the hearing of a user who has undergone a hearing test for the some frequencies of the plurality of frequencies.

2. The information processing apparatus according to claim 1, wherein the at least one processor:
sets the estimated initial value based on the acquired first test values and feature information of the user, and
sets a second test value of the hearing of the user for the frequency different from the some frequencies based on the set estimated initial value and an operation of the user who has undergone the hearing test for the frequency different from the some frequencies.

3. The information processing apparatus according to claim 2, wherein the feature information of the user includes at least one of age, gender, and a medical history.

4. The information processing apparatus according to claim 2, wherein the at least one processor determines an amplification factor of each of the plurality of frequencies in a hearing aid device based on the first test values and the second test value.

5. The information processing apparatus according to claim 1, wherein the some frequencies include at least one frequency included in a relatively low-tone range, at least one frequency included in a relatively mid-tone range, and at least one frequency included in a relatively high-tone range among the plurality of frequencies.

6. An information processing method executed by a computer, the information processing method comprising:
setting an estimated initial value of hearing for a frequency different from some frequencies of a plurality of frequencies based on first test values of the hearing of a user who has undergone a hearing test for the some frequencies of the plurality of frequencies.

7. The information processing method according to claim 6, wherein
the estimated initial value is set based on the acquired first test values and feature information of the user,
the information processing method further comprising:
setting a second test value of the hearing of the user for the frequency different from the some frequencies based on the set estimated initial value and an operation of the user who has undergone the hearing test for the frequency different from the some frequencies.

8. The information processing method according to claim 7, wherein
the feature information of the user includes at least one of age, gender, and a medical history.

9. The information processing method according to claim 7, further comprising:
determining an amplification factor of each of the plurality of frequencies in a hearing aid device based on the first test values and the second test value.

10. The information processing method according to claim 6, wherein
the some frequencies include at least one frequency included in a relatively low-tone range, at least one frequency included in a relatively mid-tone range, and at least one frequency included in a relatively high-tone range among the plurality of frequencies.

11. A storage medium for causing a computer to execute processing of setting an estimated initial value of hearing for a frequency different from some frequencies of a plurality of frequencies based on first test values of the hearing of a user who has undergone a hearing test for the some frequencies of the plurality of frequencies.
